(19) United States
(12) Patent Application Publication
(10) Pub. No.: US 2010/0199067 A1
(43) Pub. Date: Aug. 5, 2010

(54) Split Vector Loads and Stores with Stride Separated Words

(75) Inventors: Eric O. Mejdrich, Rochester, MN (US); Paul E. Schardt, Rochester, MN (US); Robert A. Shearer, Rochester, MN (US); Matthew R. Tubbs, Rochester, MN (US)

Correspondence Address: IBM Corporation, Dept. 917, 3605 Highway 52 North, Rochester, MN, 55901-7829, US

(73) Assignee: International Business Machines Corporation, Armonk, NY (US)

(21) Appl. No.: 12/363,936

(22) Filed: Feb. 2, 2009

(51) Int. Cl. G06F 9/30

(52) U.S. Cl. 712/5; 712/E09.023

(57) ABSTRACT

A method, system and computer program product are presented for causing a parallel load/store of stride-separated words from a data vector using different memory chips in a computer.

### BACKGROUND OF THE INVENTION

1. Technical Field

The present disclosure relates to the field of computers, and specifically to management of data for programs running on computers. Still more particularly, the present disclosure relates to loading and storing data vectors.

2. Description of the Related Art

Data used by computer programs is stored in and accessed from system memory in a computer. Typically, data in system memory is stored in a single memory chip. Oftentimes, the data is in the format of an array of data, which is often referred to as a data vector. In order to retrieve (i.e., load) the array of data from system memory, a processor will re-execute a single instruction multiple times, such that each re-execution loads a next unit of data from the data vector. This process, and use of a single memory chip, results in a lengthy wait and a high use of processing power whenever data from a data vector is needed by the processor.

### SUMMARY OF THE INVENTION

To address the issues described above, a method, system and computer program product are presented for causing a parallel load/store of stride-separated words from a data vector using different memory chips in a computer.

The above, as well as additional purposes, features, and advantages of the present invention will become apparent in the following detailed written description.

### BRIEF DESCRIPTION OF THE DRAWINGS

The novel features believed characteristic of the invention are set forth in the appended claims. The invention itself, however, as well as a preferred mode of use, further purposes and advantages thereof, will best be understood by reference to the following detailed description of an illustrative embodiment when read in conjunction with the accompanying drawings, where:

FIG. 1 depicts an exemplary computer in which the present invention may be implemented;

FIG. 2 illustrates additional detail of a novel configuration of memory chips used in the system memory that is depicted in FIG. 1;

FIG. 3 illustrates an exemplary stride-segmented data vector; and

FIG. 4 is a high-level flow chart of exemplary steps taken to load and store strides from a stride-segmented data vector such as that illustrated in FIG. 3.

### DETAILED DESCRIPTION OF THE PREFERRED EMBODIMENT

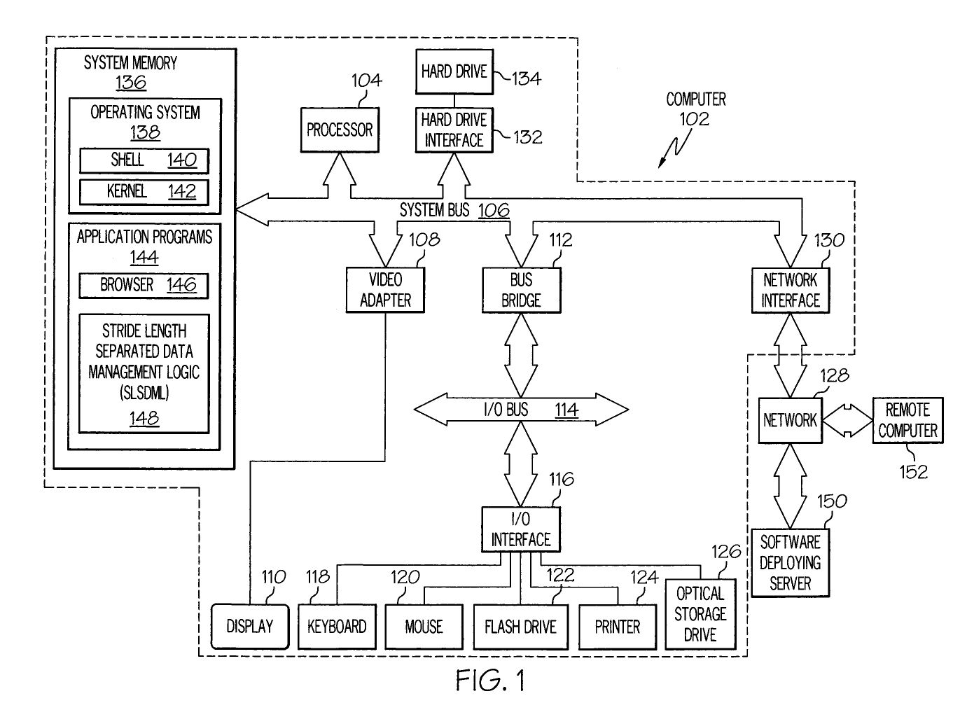

With reference now to FIG. 1, there is depicted a block diagram of an exemplary computer 102, which the present invention may utilize. Note that some or all of the exemplary architecture shown for computer 102 may be utilized by software deploying server 150.

Computer 102 includes a processor 104, which may utilize one or more processors each having one or more processor cores. Processor 104 is coupled to a system bus 106. A video adapter 108, which drives/supports a display 110, is also coupled to system bus 106. System bus 106 is coupled via a bus bridge 112 to an Input/Output (I/O) bus 114. An I/O interface 116 is coupled to I/O bus 114. I/O interface 116 affords communication with various I/O devices, including a keyboard 118, a mouse 120, a Flash Drive 122, a printer 124, and an optical storage device 126 (e.g., a CD or DVD drive). The format of the ports connected to I/O interface 116 may be any known to those skilled in the art of computer architecture, including but not limited to Universal Serial Bus (USB) ports.

Computer 102 is able to communicate with a software deploying server 150 via network 128 using a network interface 130, which is coupled to system bus 106. Network 128 may be an external network such as the Internet, or an internal network such as an Ethernet or a Virtual Private Network (VPN).

A hard drive interface 132 is also coupled to system bus 106. Hard drive interface 132 interfaces with a hard drive 134. In a preferred embodiment, hard drive 134 populates a system memory 136, which is also coupled to system bus 106. System memory is defined as a lowest level of volatile memory in computer 102. This volatile memory includes additional higher levels of volatile memory (not shown), including, but not limited to, cache memory, registers and buffers. Data that populates system memory 136 includes computer 102's operating system (OS) 138 and application programs 144.

OS 138 includes a shell 140, for providing transparent user access to resources such as application programs 144. Generally, shell 140 is a program that provides an interpreter and an interface between the user and the operating system. More specifically, shell 140 executes commands that are entered into a command line user interface or from a file. Thus, shell 140, also called a command processor, is generally the highest level of the operating system software hierarchy and serves as a command interpreter. The shell provides a system prompt, interprets commands entered by keyboard, mouse, or other user input media, and sends the interpreted command(s) to the appropriate lower levels of the operating system (e.g., a kernel 142) for processing. Note that while shell 140 is a text-based, line-oriented user interface, the present invention will equally well support other user interface modes, such as graphical, voice, gestural, etc.

As depicted, OS 138 also includes kernel 142, which includes lower levels of functionality for OS 138, including providing essential services required by other parts of OS 138 and application programs 144, including memory management, process and task management, disk management, and mouse and keyboard management.

Application programs 144 include a renderer, shown in exemplary manner as a browser 146. Browser 146 includes program modules and instructions enabling a World Wide Web (WWW) client (i.e., computer 102) to send and receive network messages to the Internet using HyperText Transfer Protocol (HTTP) messaging, thus enabling communication with software deploying server 150 and other described computer systems.

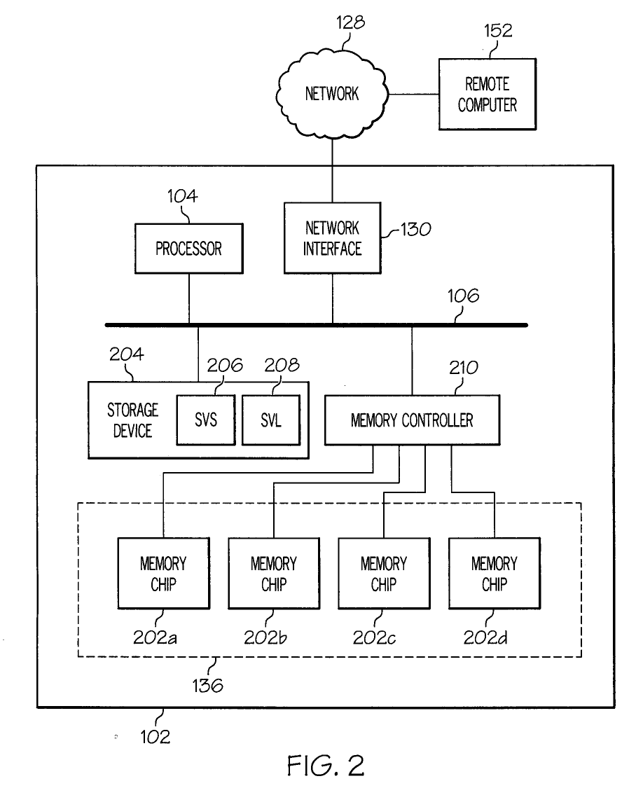

Application programs 144 in computer 102's system memory (as well as software deploying server 150's system memory) also include a Stride Length Separated Data Management Logic (SLSDML) 148. SLSDML 148 includes code for implementing the processes described below in FIGS. 2-4. In one embodiment, computer 102 is able to download SLSDML 148 from software deploying server 150, including in an on-demand basis. Note further that, in one embodiment of the present invention, software deploying server 150 performs all of the functions associated with the present invention (including execution of SLSDML 148), thus freeing computer 102 from having to use its own internal computing resources to execute SLSDML 148. In another embodiment, SLSDML 148 is executed by another remote computer 152, such that the remote computer 152 is able to parallel load/store strides from a data vector from the remote computer 152 into the system memory 136 of computer 102.

The hardware elements depicted in computer 102 are not intended to be exhaustive, but rather are representative to highlight essential components required by the present invention. For instance, computer 102 may include alternate memory storage devices such as magnetic cassettes, Digital Versatile Disks (DVDs), Bernoulli cartridges, and the like. These and other variations are intended to be within the spirit and scope of the present invention.

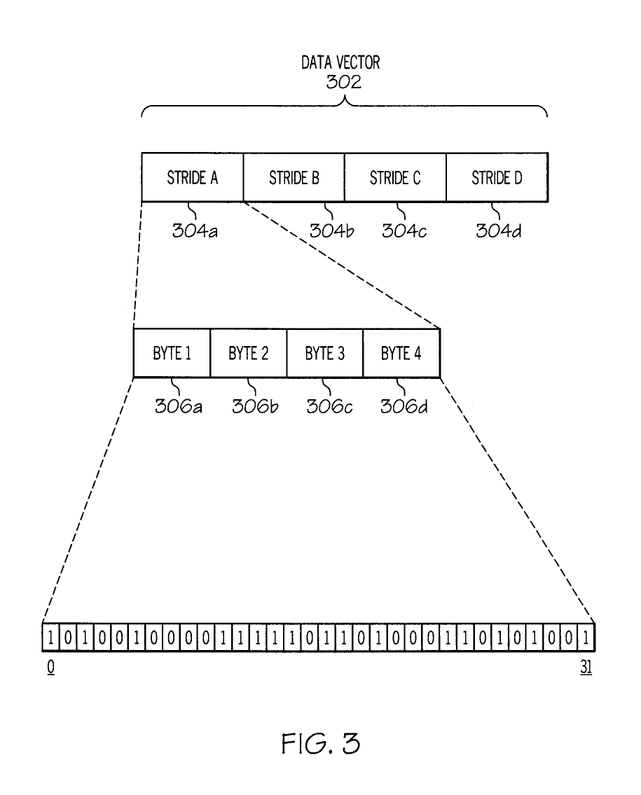

With reference now to FIG. 2, additional exemplary detail of system memory 136 in the computer 102 presented in FIG. 1 is illustrated. Note that, in accordance with the present invention, system memory 136 comprises multiple memory chips 202a-d. Note that while “d” may be any integer, assume for purposes of illustration that there are four memory chips 202a-d. Each of the memory chips 202a-d is dedicated to storing a particular user-defined stride from a data vector. For example, consider data vector 302 depicted in FIG. 3, which may be data (e.g., operands used by computer-executable code) or instructions (computer-executable code). In an exemplary embodiment, data vector 302 has been divided by a user into four strides 304a-d. Each of the four strides 304a-d is made up of four bytes (e.g., bytes 306a-d for stride 304a), making up a 32-bit width for each of the user-defined strides 304a-d. With reference again to FIG. 2, assume that memory chip 202a is dedicated to load/storing stride 304a, memory chip 202b is dedicated to load/storing stride 304b, memory chip 202c is dedicated to load/storing stride 304c, and memory chip 202d is dedicated to load/storing stride 304d. Assume also that each of the strides 304a-d are user-defined to hold up to four bytes (32 bits—some or all of which may actually be used at any point in time), thus giving each of the strides 304a-d the same 32 bit-width. Assume also that each of the memory chips 202a-d can be parallel accessed (through multiple pins) such that each 32-bit wide stride can be accessed in parallel. That is, each of the memory chips 202a-d can provide a 32-bit wide stride during a single clock cycle, and all of the memory chips 202a-d can be accessed (i.e., support a load/store operation) during that same single clock cycle.

Returning now to FIG. 2, assume that a storage device 204 in computer 102 holds a Strided Vector Store (SVS) command 206 and a Strided Vector Load (SVL) command 208. Although depicted as two separate commands, SVS 206 and SVL 208 may be combined into a single load/store command. Note also that, for purposes of illustrating the functionality of SVS command 206 and SVL command 208, storage device 204 is depicted as a separate hardware logic from the system memory 136. In a preferred embodiment, however, storage device 204 and system memory 136 are a same hardware logic.

When SVS command 206 is executed by processor 104, a memory controller 210 causes an entire data vector (e.g., the data vector 302 shown in FIG. 3) to be parallel-stored such that each of the strides 304a-d is stored in a different memory chip that has been pre-selected from the memory chips 202a-d. Alternatively, SVS command 206 can be executed in a manner such that only some of the strides (e.g., 304a and 304c) are stored in some of the memory chips (e.g., 202a and 202c).

Similarly, when SVL command 208 is executed, one or more user-selected strides are loaded from the memory chips 202a-d into a register or cache (not shown) in the processor 104. Even if the SVS command 206 stored all of the strides from the data vector 302 into the memory chips 202a-d, SVL command 208 is user-adaptable to retrieve only some of the strides (e.g., 304b and 304c).

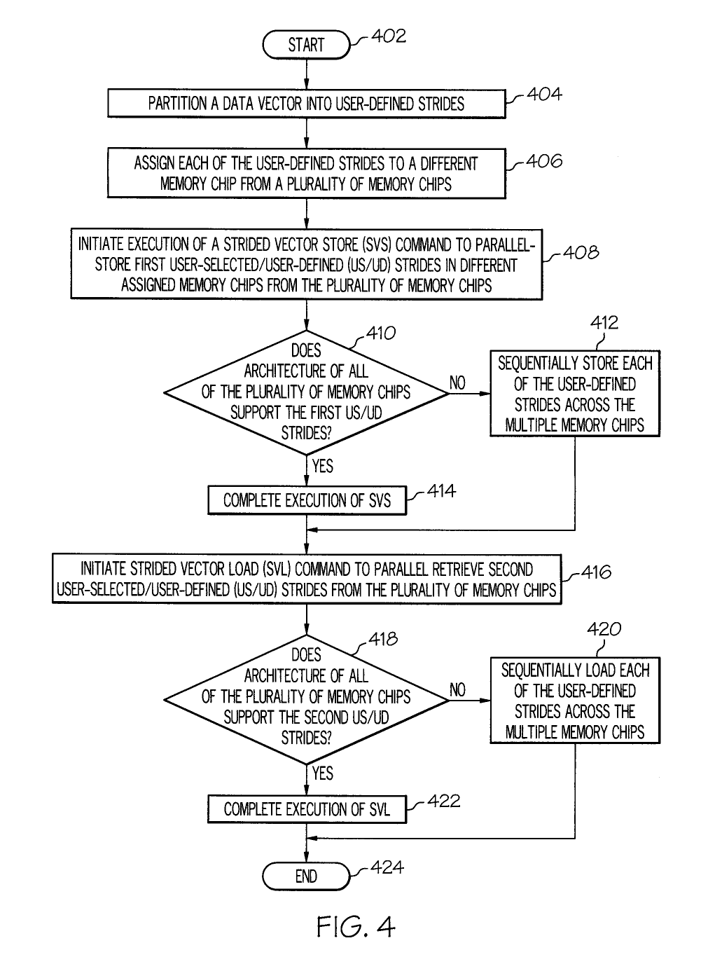

With reference now to FIG. 4, a flow-chart of exemplary steps taken to parallel manage vector data is presented. After initiator block 402, a data vector is partitioned into a set of user-selected/user-defined strides (e.g., a user selects a user-defined bit-width that is applied to all of the strides in the data vector), as described in block 404. A processor and/or memory controller then assigns each of the user-defined strides to a different memory chip within the computer (block 406). When a Strided Vector Store (SVS) command is executed by the processor, all of the strides from the data vector are parallel stored from the processor into the memory chips (block 408). If (query block 410) the architecture of the memory chips does not support the user-defined strides (i.e., if all of the necessary memory chips are not hard-wired to parallel store an entire stride at once), then the data vector is stored by a series of sequentially executed steps in which each stride is stored into system memory (block 412). If sequential storage occurs, then multiple strides may be stored into a single memory chip, or a single stride may be separated such that part of that single stride is stored in a first memory chip and the rest of that single stride is stored in one or more other memory chips. Returning to query block 410, if the memory chips support the SVS command, then execution of the SVS completes (block 414).

Just as a stride-dependent store can occur, a stride-dependent load can also be executed by a Strided Vector Load (SVL) command. When initialized, the SVL command begins parallel retrieval of the strides from the computer chips (block 416). If the computer chips do not support such stride bid-widths (query block 418), then the data vector must be retrieved sequentially such that each stride is sequentially retrieved from the memory chips (block 420). However, if the memory chips support the stride size, then all requested strides are parallel retrieved (block 422). The process ends at terminator block 424.

Note that the SVS command and the SVL may store all or some of the data vector. That is, consider the following pseudo code for SVS:

SVS(1,3) Data Vector 302

This command instructs the memory controller to parallel store strides “1” and “3” from “Data Vector 302.” The memory controller knows which memory chips to load these strides in (as described above). If “(1,3)” were not in the pseudo code, then all of “Data Vector 302” would have been parallel stored.

Assume now that all of the data vector 302 was previously stored (e.g., using the SVS command) in the memory chips. Consider then the following pseudo code for SVL:

SVL (2,4) Data Vector 302

This commands instructs the memory controller to selectively parallel load only strides “2” and “4” from the “Data Vector 302” that is stored in pre-selected memory chip. If “(2,4)” were not in the pseudo code, then all of “Data Vector 302” would have been parallel loaded.

It should be understood that at least some aspects of the present invention may alternatively be implemented in a computer-readable medium that contains a program product. Programs defining functions of the present invention can be delivered to a data storage system or a computer system via a variety of tangible signal-bearing media, which include, without limitation, non-writable storage media (e.g., CD-ROM), writable storage media (e.g., hard disk drive, read/write CD ROM, optical media), as well as non-tangible communication media, such as computer and telephone networks including Ethernet, the Internet, wireless networks, and like network systems. It should be understood, therefore, that such signal-bearing media when carrying or encoding computer readable instructions that direct method functions in the present invention, represent alternative embodiments of the present invention. Further, it is understood that the present invention may be implemented by a system having means in the form of hardware, software, or a combination of software and hardware as described herein or their equivalent.

While the present invention has been particularly shown and described with reference to a preferred embodiment, it will be understood by those skilled in the art that various changes in form and detail may be made therein without departing from the spirit and scope of the invention.

Furthermore, as used in the specification and the appended claims, the term “computer” or “system” or “computer system” or “computing device” includes any data processing system including, but not limited to, personal computers, servers, workstations, network computers, main frame computers, routers, switches, Personal Digital Assistants (PDA's), telephones, and any other system capable of processing, transmitting, receiving, capturing and/or storing data.

What is claimed is:

1. A computer-implemented method of managing data in a data vector, the computer-implemented method comprising:
partitioning a data vector into user-defined strides;
assigning each of the user-defined strides to a different memory chip for storage in a computer; and
initiating a Strided Vector Store (SVS) command, wherein the SVS command causes first user-selected/user-defined strides from the data vector to be parallel stored in different memory chips in the computer.

2. The computer-implemented method of claim 1, wherein all of the user-defined strides in the data vector are of a same size.

3. The computer-implemented method of claim 1, wherein the SVS command is initiated internally by the computer.

4. The computer-implemented method of claim 1, wherein the SVS command is initiated within a network that is coupled to the computer.

5. The computer-implemented method of claim 1, wherein the different memory chips are a system memory in the computer.

6. The computer-implemented method of claim 1, wherein each of the user-defined strides are stored in the different memory chips without regard as to whether a particular user-defined stride has data or not.

7. The computer-implemented method of claim 1, wherein the data vector contains only operand data.

8. The computer-implemented method of claim 1, wherein the data vector contains only instructions.

9. The computer-implemented method of claim 1, further comprising:
in response to determining that the different memory chips all support a bit-width of the first user-selected/user-defined strides, completing execution of the SVS command to complete a parallel storing of the first user-selected/user-defined strides from the data vector.

10. The computer-implemented method of claim 1, further comprising:
in response to determining that the different memory chips do not all support a bit-width of the first user-selected/user-defined strides, stopping execution of the SVS command and executing a sequential store of the first user-selected/user-defined strides across the different memory chips in the computer, wherein a single user-defined stride is stored in different memory chips.

11. The computer-implemented method of claim 1, further comprising:
in response to determining that the different memory chips do not all support a bit-width of the first user-selected/user-defined strides, stopping execution of the SVS command and executing a sequential store of the first user-selected/user-defined strides across the different memory chips in the computer, wherein multiple user-defined strides are stored in a same memory chip.

12. The computer-implemented method of claim 1, further comprising:
initiating a Strided Vector Load (SVL) command, wherein the SVL command parallel retrieves at least one second user-selected/user-defined stride from the different memory chips, and wherein the second user-selected/user-defined stride comprises at least one stride from the first user-selected/user-defined strides.

13. The computer-implemented method of claim 12, further comprising:
in response to determining that the different memory chips all support a bit-width of second user-selected/user-defined strides, completing execution of the SVL command to complete a parallel loading of the second user-selected/user-defined strides from the different memory chips.

14. The computer-implemented method of claim 12, further comprising:
in response to determining that the different memory chips do not all support a bit-width of second user-selected/user-defined strides, stopping execution of the SVL command and executing a sequential load of the second user-selected/user-defined strides from the different memory chips in the computer.

15. The computer-implemented method of claim 12, wherein the first user-selected/user-defined strides and said at least one second user-selected/user-defined stride comprise a different number of strides from the data vector, and wherein the SVL command selectively loads less than all of the second user-selected/user-defined strides.

16. A system comprising:
a system bus;
a processor coupled to the system bus;
a memory controller coupled to the system bus;
a plurality of memory chips coupled to the memory controller; and
a storage device coupled to the system bus, wherein encoded in the storage device is a Strided Vector Store (SVS) command, and wherein the SVS command, upon execution by the processor, causes the memory controller to parallel store first user-selected/user-defined strides from a data vector into different memory chips from the plurality of memory chips.

17. The system of claim 16, wherein the storage device further stores a Strided Vector Load (SVL) command, wherein the SVL command, upon execution by the processor, causes the memory controller to parallel load at least one second user-selected/user-defined stride from the plurality of memory chips into the processor, and wherein the second user-selected/user-defined stride comprises at least one stride from the first user-selected/user-defined strides.

18. A computer-readable storage medium on which is encoded a computer program, the computer program comprising computer executable instructions configured for:
partitioning a data vector into user-defined strides;
assigning each of the user-defined strides to a different memory chip for storage in a computer; and
initiating a Strided Vector Store (SVS) command, wherein the SVS command causes first user-selected/user-defined strides from the data vector to be parallel stored in different memory chips in the computer.

19. The computer-readable storage medium of claim 18, wherein the computer executable instructions are further configured for:
initiating a Strided Vector Load (SVL) command, wherein the SVL command parallel retrieves at least one second user-selected/user-defined stride from the different memory chips, and wherein the second user-selected/user-defined stride comprises at least one stride from the first user-selected/user-defined strides.

20. The computer-readable storage medium of claim 18, wherein the computer executable instructions are deployed to the processor from a service provider server in an on-demand basis.
